(19) United States
(12) Patent Application Publication
(10) Pub. No.: US 2022/0162802 A1
(43) Pub. Date: May 26, 2022

(54) PULP FOR PAPER, BOARD OR CARD AND THE PROVISION AND USE THEREOF

(71) Applicant: RICOLA GROUP AG, Laufen (CH)

(72) Inventors: Sabin-Mihai BARA, Weil am Rhein (DE); Raymond PLACE, Basel (CH)

(73) Assignee: RICOLA GROUP AG, Laufen (CH)

(21) Appl. No.: 17/611,831

(22) PCT Filed: May 18, 2020
(86) PCT No.: PCT/EP2020/063850

§ 371 Date: Nov. 16, 2021

(30) Foreign Application Priority Data
May 28, 2019 (CH) 00693/19

(51) Int. Cl. D21H 11/12; D21C 3/26

(52) U.S. Cl. CPC D21H 11/12; D21C 3/263

(57) ABSTRACT

Paper, board and/or card and a fibrous mixture for producing the same are disclosed. The mixture includes a fraction of fibrous material got from broad-leaved plants and a fraction of pulp. The fibrous broad-leaved plant material is preferably produced from a pomace, especially a food production pomace, and is used to produce packaging for the food from which the pomace was obtained.

The invention relates to a fibre material mixture and a method for providing a fibre material for the production of paper, paperboard and/or cardboard, in particular paper, paperboard and/or cardboard as packaging material.

For packaging individual goods or bulk goods, especially in the food industry, fibre material packaging from paper, paperboard and/or cardboard is often used. Depending on the product to be packaged, different requirements are posed on the packaging material used, such that fibre material packaging with different properties have been established.

These usually differ in their grammage, strength and printability. A difference is made between e.g. tissue paper, glassine, sack paper and wrapping paper. The properties of the different fibre material packaging are mainly determined by the fibre material composition and the processing of the fibre materials in the production of the packaging material.

In the production of paper, paperboard and cardboard, fibre materials of various types and origins are used. Wood is the most important primary fibre raw material and is often used in combination with fibres from annual plants, rags, synthetic fibres, animal fibres and waste paper. For retrieval of the fibres from wood, it is chopped and converted into its fibre raw materials lignin, cellulose and hemicellulose, which are subsequently decomposed. Depending on the extraction and the amount of residual lignin, a distinction is made between the following types of fibre material: wood pulp from mechanical defibration, semi-pulp from a chemical-mechanical decomposition process, pulp from a chemical extraction process, and waste paper as secondary fibre materials.

Although the use of waste paper in paper production is increasing and the energy consumption of production could be reduced, the CO₂ emissions of the paper and cardboard industry are rising steadily. About one fifth of the worldwide wood harvesting reverts to paper production.

The water consumption in the treatment and processing of fibre materials and the production of paper, paperboard and cardboard is very high. The consumption is between 15,000 l/t paper (wood pulp) and 80,000 l/t paper (bleached sulphate pulp), depending on the decomposition process. The paper production requires water primarily for cleaning purposes, auxiliary purposes and the pulper (approx. 10,000 l/t paper). Furthermore, the soil water is already polluted with ammonium, nitrate and an increase in the chemical oxygen demand (COD) from the wood harvesting by machines and fertilizers. Due to the use of different chemicals, all fibre decomposition processes lead to high wastewater pollution.

The fibre decomposition process also results in severe air pollution, since a large number of chemical substances (e.g. CO₂, CO, NOx) are released thereby. For example, the CO₂ release in wood pulp retrieval is as high as 367 kg/t paper and with bleached sulphite pulp up to 560 kg/t paper.

Here, recycled fibres have an ecological advantage. Even during the actual fibre retrieval, it is evident that the forest ecosystem is protected in many aspects by the greatly reduced wood harvest. For example, less dust, noise and dirt pollution occurs on site. Compared to the pulp pulping process, the pulping processes of recycled fibres are comparatively water-saving and leaner in process chemicals.

Notwithstanding, papermaking cannot manage with a recycling loop without fresh fibres. Since recycled fibres lose their fibre stability and length after being recycled 4-6 times, they are unsuitable for a further production run. For this reason, primary fibres have to be added to the system repeatedly.

Therefore, there is a need for alternatives to primary fibre materials from wood and secondary fibre materials from recycled fibres. These can be produced e.g. from plants such as grass or grain.

From WO 2015/091627 A1 a method is known e.g. for the processing of grass for the production of paper, paperboard and cardboard. The special features of the fibre raw material are dealt with by pre-shredding grass or hay with subsequent removal of foreign matter and further shredding and fibrillating milling with subsequent shredding. Furthermore, from EP 2825699 B1 the production of a fibre material composition from sweet grass, sour grass, seaweed or algae with the addition of fresh fibres or waste paper is known. The processing of grass and grain as fibre material is mostly based on purely mechanical processes and therefore does not require any chemical additives and only small amounts of water. The problem with the known processes for paper production in which grass or grain are used as fibre material is the small contribution of these materials to the strength and smoothness of the paper, paperboard or cardboard produced. Furthermore, problems arise in the processing of suspensions with fractions of grass or grain in the field of manufacturing machines, since this can lead, e.g. to blockages.

It is therefore an object of the present invention to provide a method for providing a fibre material and a fibre material mixture for the production of paper, paperboard and/or cardboard, which meet existing demands on paper quality, such as strength, which enable a cost-saving and efficient procedure and processing, which avoid environmental pollution, and which offer advantages for the packaging of products and thereby have a positive effect on the environmental balance of packaging and product.

This object is achieved according to the invention by a fibre material mixture for the production of paper, paperboard and/or cardboard according to claim 1, a method for providing a fibre material therefor according to claim 10, a method for producing paper, paperboard and/or cardboard according to claim 16, by a paper, a paperboard and/or a cardboard according to claim 18, and a food packaging according to claim 19. Advantageous arrangements and different embodiments of the invention emerge from the dependent claims.

A fibre material mixture for the production of paper, paperboard and/or cardboard according to the present invention contains a fraction of fibre material retrieved from herbs and a fraction of pulp. Herbs are to be understood as meaning all plants that are used as kitchen herbs, aromatic herbs or medicinal herbs in the production of food. The herbs can be fresh or dried. Also plants with essential oils should be understood as herbs. The oils can give the plants, and thus the fibre materials, a characteristic scent. The pulp fraction of fibre materials in the fibre material mixture can be a pulp retrieved from a chemical extraction processes and/or a semi-pulp retrieved from a chemical-mechanical decomposition processes.

With a fibre material mixture according to the present invention, paper, paperboard and/or cardboard can be produced which have a characteristic appearance. For example, they can have a beige to greenish tone. A surface structure characteristic of the herbs is also possible. For example, herb components can appear on the surface. In particular, the olfactory characteristics give the paper, paperboard and cardboard according to the invention an individual character compared to conventional products. Depending on the herbs used, the paper, paperboard or cardboard may have a special odour tone.

Preferably, the fibre material mixture according to the invention has a fraction of herb fibre material of 5% to 70%, preferably 30% to 60%, and particularly preferably 40% to 50%, of a total weight of fibre materials in the mixture. It is obvious that all weight fractions together result in a total weight of fibre materials in the mixture of 100%. According to this, 30% to 95% of the mixture consists of a different fibre material. In particular, this other fibre material fraction includes the pulp content. However, other types of pulp can also be contained in this other fraction, such as fibre material from grass, grain, or other annual plants or recycled fibre materials.

Preferably, the herb fibre material for the fibre material mixture is retrieved from a herb pomace. The pomace is to be understood as the residues that remain after pressing out aqueous, organic or mixed components from the herbs. Such a herb pomace is created e.g. in the production of food from herbs, especially from herb extract in a liquid extraction. The pomace is created by pressing or sieving.

According to a further aspect of the present invention, a packaging for a food is provided, which is at least partially made of paper, paperboard and/or cardboard, which has a fraction of fibre material retrieved from a pomace resulting from the production of the food. In particular, in the case of a food made at least partially from herbs, a fraction of fibre material is provided in the packaging from a herb pomace. Paper, paperboard or cardboard for packaging are advantageously made from a fibre material mixture according to the invention. Furthermore, the herb fibre material in the packaging can advantageously be provided by the method according to the invention described below.

With an overall view of the resources required for a food, as well as its production, distribution and use, this results in various advantages. Fibre materials for the production for packaging can be at least partially substituted by residues originating from food production. This reduces the consumption of resources in the life cycle of the food, since additional resources required for the production of the packaging, such as wood and energy for processing it, are replaced by pomace. The use of food pomace in the packaging of the food also reduces the influence of foreign substances on the food.

In an embodiment of a fibre material mixture according to the present invention, the fraction of herb fibre material can consist of a mixture of fibre materials retrieved from different herb species. This allows to vary the characteristic features of the paper produced with the mixture. However, the fraction of herb fibre material can also be retrieved from just one type of herb.

Advantageously, the herbs for retrieval of the herb fibre material for the fibre material mixture are selected from the herb species burnet, speedwell, sage, elderflower, thyme, ribwort, lady's mantle, primrose, mallow, horehound, peppermint, yarrow, marshmallow, verbena, hops, chamomile, poppy, lavender, orange blossom, orange leaves, rose blossom, vervain, apple mint, nettle, bergamot mint, ginger mint, lime mint, stevia and/or subspecies thereof.

These herbs can give the paper, paperboard and/or cardboard a special optical and olfactory tone. Furthermore, good results with regard to fibre length and fibre quality were achieved when these herb species were decomposed as fibre raw materials. Other herb species that are suitable for the fraction of herb fibre material in the fibre material mixture are, e.g. basil, mugwort, savory, watercress, dill, lovage, marjoram, lemon balm, parsley, rosemary, chives, thyme and juniper.

Advantageously, the fibre material mixture according to the present invention contains a weight fraction of 30% to 95% of pulp, preferably 40% to 70%, and particularly preferably 50% to 60%. With such a fraction of pulp, a good fibre connection and fibre alignment is achieved in the production of paper, paperboard or cardboard, as a result of which these have good strength and printability. Due to the remaining weight fraction of herb fibre materials they obtain the characteristic features of an herb fibre paper, paperboard or cardboard according to the invention. In particular, they obtain a desired opacity.

The pulp fraction is advantageously composed of a larger part of short-fibre pulp and a smaller part of long-fibre pulp. For example, the pulp fraction of the fibre material mixture comprises 60% short-fibre pulp and 40% long-fibre pulp. As short-fibre pulp a pulp with fibres having a length between 0.25 mm and 0.70 mm is used. As long-fibre pulp a pulp with fibres having a length between 0.70 mm and 1.40 mm is used. Slight deviations from these lengths are possible.

In an embodiment of the fibre material mixture according to the present invention, in addition to the herb fibre material fraction and the pulp fraction, the mixture can also contain a fraction of fibre material retrieved from grass. Advantageously, a weight fraction of grass fibre material corresponds to half of the weight fraction of herb fibre material to the double of the weight fraction of herb fibre material. If, for example, a weight fraction of 20% herb fibre material is provided, the fraction of grass fibre material may be 10% to 40%. The addition of grass fibre material favours the binding of the fibre materials in the production of paper, paperboard or cardboard, such that an improved stability is obtained.

In an advantageous embodiment of the fibre material mixture according to the present invention, the mixture has a weight fraction of 20%-30% herb fibre material, preferably 25% herb fibre material, a weight fraction of 20%-30% grass fibre material, preferably 25% grass fibre material, and a weight fraction of at least 40% pulp, preferably 50% pulp. The pulp content preferably consists of 60% short-fibre pulp and 40% long-fibre pulp. This means that there is preferably a weight fraction of 30% short-fibre pulp and a weight fraction of 20% long-fibre pulp in the fibre material mixture. With this composition, the best quality results were achieved in tests for a paper, paperboard or cardboard made from the fibre material mixture, as will be explained below. In particular, good values for tear length, tear strength and flexural rigidity were achieved with this fibre material mixture.

According to a further aspect, the invention comprises a method for providing a fibre material for the production of paper, paperboard and/or cardboard, in which herbs are used as fibre raw material, which are mechanically and/or chemically decomposed for retrieval of the fibre material. The herbs serve as fibre raw material that is separated into its fibre components and its remaining fibres when it is decomposed and wherein the fibre components are separated into a fibre material. A mechanical decomposition can e.g. be done by milling, optionally with heat supply, if this is useful for a simpler fibre decomposition. Preferably, a fibre decomposition of the herb fibre raw material is performed by pressing out the herb material and subsequently separating the herb fibres. The pressed components can advantageously be used for food production as herb extracts. In an advantageous process according to the present invention, the herbs are processed into a pomace in which the herb cellulose remains and other herb components are extracted.

For the method, preferably, herbs can be used, selected from the herb species burnet, speedwell, sage, elderflower, thyme, ribwort, lady's mantle, primrose, mallow, horehound, peppermint, yarrow, marshmallow, verbena, hops, chamomile, poppy, lavender, orange blossom, orange leaves, rose blossom, vervain, apple mint, nettle, bergamot mint, ginger mint, lime mint, stevia and/or subspecies thereof. However, the use of other herb species and mixtures thereof as indicated above is also conceivable for the process.

In an embodiment of the method according to the invention, a herb pomace, produced from the herbs, is dried at a temperature between 50° C. and 140° C., preferably between 100° C. and 130° C., particularly preferably at 125° C. Thereby a residual moisture of less than 10% can be achieved. At these temperatures, a gentle and homogeneous drying can be achieved without leaving any pockets of moisture. For drying the pomace can e.g. a drum dryer be used.

In a further variant of the method, after drying, the herb pomace is milled in a first milling process to a fibre length of 5 mm to 10 mm, preferably at most 8 mm. With these fibre lengths of the herb fibre material, a good connection with and fibre alignment with the fibre materials of the fibre material mixture was achieved in papermaking. For milling the dried herb fibres can, e.g. a hammer mill be used.

The dried herb fibres, which are milled in the first milling process, advantageously pass through a second milling process in a press. Thereby, they are milled to a size of 5 mm to 8 mm. Subsequently, the herb fibre material is pelletised. For the second milling process and the pelletising, a pan grinder press can be used. Advantageously, the herb fibre material according to the invention can then be provided in pellets with a length between 5 mm and 20 mm.

According to yet another aspect of the present invention, a paper, paperboard or cardboard with a fraction of herb fibre material and a method for producing such a paper, paperboard or cardboard is proposed. Advantageously, a fibre material mixture according to any one of the embodiments described above is used, the herb fibre material preferably being provided pursuant to an aforementioned method.

Such a method and the paper, paperboard or cardboard retrieved therefrom have the aforementioned advantages. They are efficient in using resources. Paper, paperboard and cardboard can be given individual characteristics. Fibre material packaging made from thereof can harmonize with the food packaged therewith. The production of a food and its packaging can be linked to each other in the sense of a technical and economic cycle and can benefit from each other.

In an advantageous variant of the production process, the fibre material mixture according to the invention is whipped with water to form a suspension and the fibre materials in the suspension are milled with a freeness of 2500 to 3500 revolutions, preferably about 3000 revolutions. Such a freeness allows a good fibrillation of the fibres, with the secondary fibre walls exposed by squeezing and the fibre surfaces enlarged. This results in an improved fibre-fibre cohesion in paper, paperboard or cardboard.

The production of paper, paperboard and/or cardboard from this suspension can be carried out according to known production processes. Exemplary processes in laboratory tests and for industrial implementation are shown below in the detailed description of the invention.

The invention is explained in more detail by means of examples, tests and figures. These are only intended to illustrate the concept of the invention and are not to be interpreted as restrictive. They show:

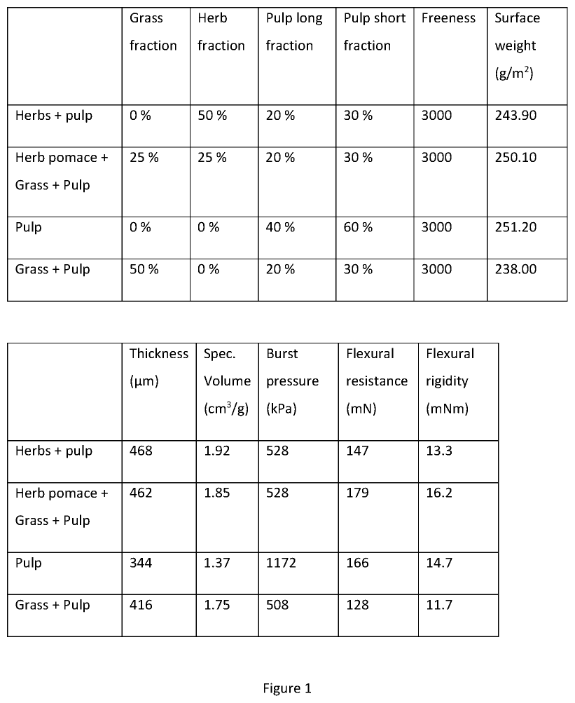

FIG. 1: Table of test results for four selected tests to produce paper, paperboard and/or cardboard in connection with herb fibre materials according to the present invention, and

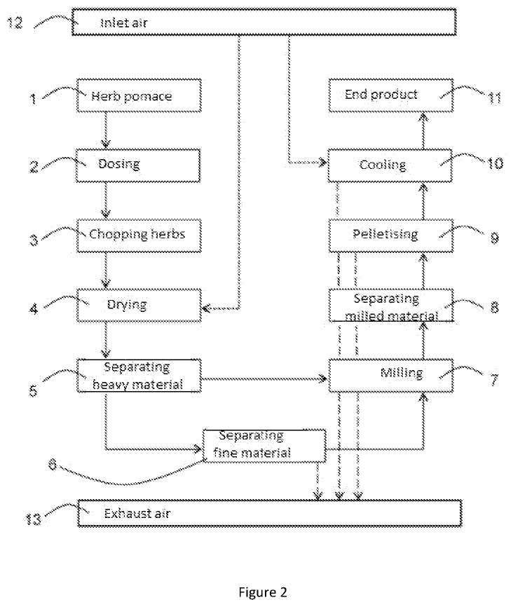

FIG. 2: Diagram of a process sequence for drying during a process according to the invention for the provision of a herb fibre material.

For the production of food packaging from paper, paperboard and/or cardboard according to the present invention, a fibre material mixture is used which contains a fraction of fibre material retrieved from herbs and a fraction of pulp. From this fibre material mixture paper, paperboard and/or cardboard are made for food packaging.

The pulp used is e.g. retrieved by a sulphite or a sulphate process. Both processes dissolve lignin from wood fibres through chemical reactions during a cooking process lasting several hours, whereby the fibres remain undamaged and in full length. As a result, pulp has a higher basic whiteness and a higher tensile strength compared to wood pulp. To further increase the whiteness of pulp, it can be bleached with oxygen, hydrogen peroxide or sodium chloride after the decomposition process.

The fraction of fibre material retrieved from herbs is advantageously retrieved from a pomace that is produced during the production of food such as candies, tea extract, spices, etc. For the production of the pomace, the herbs are pressed, milled or grated to release their ingredients. Due to the extraction of the herb ingredients, only the herb cellulose and thus the component important for fibre material production remain. When producing fibre material packaging for the food from which the herb pomace originates, upcycling can be achieved, which reduces the need for fresh fibre material in the packaging production.

To provide herb fibre material from pomace, two tests were carried out in which herb pomace was obtained from a food producer and herb fibre material was retrieved therefrom. The pomace is preferably removed directly behind a system for extracting the herb ingredients. In this way, contamination of the pomace can be prevented and, if necessary, the necessary hygiene standards can be met.

In a first test, a mixed pomace was used, which was retrieved from a mixture of the following herb species: burnet, speedwell, sage, elderflower, thyme, ribwort, lady's mantle, primrose, mallow, horehound, peppermint, yarrow, lime blossom, lemon balm, orange mint, hyssop and marshmallow.

To dry the mixed pomace, a drying cabinet with a temperature of 40° C. and activated fan was used. The herbs were divided into dry baskets. To avoid moisture pockets, a low layer height is used in the dry baskets. Furthermore, the herb material is turned from time to time. After about 24 hours, the dry matter content was about 90%. A higher temperature is recommended to reduce the drying time. In a second test, a tea pulp was used that was retrieved from a mixture of the following herb species: burnet, speedwell, sage, elderflower, thyme, ribwort, lady's mantle, primrose, mallow, horehound, peppermint, yarrow, lime blossom, lemon balm, hyssop and marshmallow. A temperature of 60° C. was used. This enabled the drying time to be shortened to less than 18 hours. In addition, this test did not result in the formation of moisture pockets, which suggests more homogeneous drying. In this test, too, a dry content of a nearly 92% was achieved. Furthermore, the second drying test clearly showed that it is important for a later, industrial solution to ensure a low layer thickness or a thorough mixing of the pomace. Only in this way the formation of moisture pockets and the associated long drying time can be prevented.

With the herb fibre materials thus retrieved, laboratory tests were carried out to produce a cardboard for packaging with a grammage between 250 g/m² and 260 g/m², which are based on different fibre material mixtures. The laboratory tests are intended to serve as the basis for industrial production of such a packaging cardboard.

In the first tests, the workability and the technical effects of the individual pomace were examined. The fibre material mixtures with herb fibre fraction listed below were used for the test samples.

| Type of herb | Herb frac- | Grass | Pulp long | Pulp short | Wood pulp |
|---|---|---|---|---|---|
| pomace | tion | fraction | fraction | fraction | fraction |
| Mixed pomace | 50% | 0% | 20% | 30% | 0% |
| Mixed pomace | 25% | 25% | 20% | 30% | 0% |
| Tea pomace | 50% | 0% | 20% | 30% | 0% |
| Tea pomace | 25% | 25% | 20% | 30% | 0% |

Freeness of 0, 500, 1000 and 3000 revolutions were used for each of the fibre material mixtures.

In second tests, it was tested to replace—because of its origin—ecologically “bad”, short-fibre pulp, with wood pulp or the like. Thereby, exclusively the freeness of 3000 revolutions was used since this had proven to be optimal in the first tests. The fibre material mixtures listed below were selected for the test samples.

| Type of herb | Herb frac- | Grass | Pulp long | Pulp short | Wood pulp |
|---|---|---|---|---|---|
| pomace | tion | fraction | fraction | fraction | fraction |
| Mix + tea | 30% | 25% | 25% | 0% | 20% |
| Mix + tea | 30% | 25% | 30% | 0% | 15% |
| Mix + tea | 30% | 20% | 25% | 0% | 25% |
| Mix + tea | 45% | 25% | 20% | 0% | 10% |
| Mix + tea | 25% | 20% | 20% | 20% | 15% |
| Mix + tea | 30% | 20% | 15% | 25% | 10% |
| Mix + tea | 60% | 20% | 0% | 0% | 20% |
| Mix + tea | 40% | 20% | 40% | 0% | 0% |

In third tests, a pulp board was made from a fibre material mixture without herb fibres in order to get a direct, technical comparison with a non-machine-made pulp board. The fibre material mixtures listed below were chosen for the test samples and a freeness of 3000 revolutions was chosen.

| Type of herb | Herb frac- | Grass | Pulp long | Pulp short | Wood pulp |
|---|---|---|---|---|---|
| pomace | tion | fraction | fraction | fraction | fraction |
| — | 0% | 0% | 40% | 60% | 0% |
| — | 0% | 50% | 20% | 30% | 0% |

After the individual fractions of fibre raw materials for the fibre material mixtures have been weighed, they are whipped in water in a whipping device for about 15 minutes and mixed. The fibres dissolve in the water and form a suspension.

After the fibres have been mixed, they are mechanically separated from the water via a suction filter (Buchner funnel), such that a fibre cake is formed. This is necessary to enable milling under standardised conditions. The fibres are milled by a PFI mill, which mills according to DIN EN 25264-2, by a defined number of mill wheel revolutions (freeness number=number of revolutions). To carry out the milling, the fibre cake separated from the water is brought to a defined 300 g by adding water. The resulting fibre mass is then evenly distributed in the milling chamber and the milling process is started. After the defined milling revolutions have completed, the milled material is poured into a distribution vessel and filled with water. 10 ml of water per gram of surface weight of the later sheet are required in the distribution vessel. This results in the final fibre suspensions with which the tests for sheet formation with the fibre material mixtures listed above can be carried out.

The laboratory-sized sheet formation for these tests takes place in two main steps, the sheet formation and the drying. The sheet formation is also divided into several process sections, which should guarantee a comparable and reproducible sheet quality.

To start, a container of a sheet former is filled with water. The prepared final fibre suspension is added to the water. In order to achieve a homogeneous fibre distribution in the resulting suspension, air is supplied in the form of aeration. After the aeration has been stopped, the suspension is left to rest. Subsequently, the water is removed from the suspension and the fibres remain on a sieve in the sheet former. A sheet that forms in the process is knocked off the screen after coating, preferably with a release paper. After the sheet has been produced by the sheet former, it is present as a thin fibre layer on the release paper. Only after a drying process, for example in a steam-heated vacuum press, is the finished, the finished, dry sheet of paper, paperboard or cardboard is removed from the release paper.

The sheets produced with the laboratory tests were examined for their quality. Measurements were made for the surface weight, the thickness, the specific volume, the bursting pressure, the bending resistance and the bending stiffness. The measurements were carried out according to the usual procedures. For the determination of tear length/strength and flexural strength, the specifications of the ISO 1924-2 and ISO 2493 standards were complied with. Before starting the measurements, it was ensured that the samples are adequately air-conditioned in the standard climate. This provides reproducible and correct results. Measurements were made as follows.

Surface weight: The measurement of the surface weight was carried out by placing the sheet in a tared balance and automatically calculating the measured value. After completing the measurements, the surface weight could be read from the display of the balance in g/m².

Thickness: The measurement of the thickness was carried out on a cyclic thickness measuring device which outputs the measured value in micrometres. Five measurements per sheet were carried out at different points (edge, centre, etc.). From these measurements, the average value was subsequently calculated. Herewith, the spec. volume can be calculated by dividing it with the surface weight determined in each case.

Tear length: In order to be able to measure the tear length, a profile had to be created for each sheet beforehand, in which the previously determined values of surface weight and thickness were entered. This allows the measuring device to automatically calculate the tear length of the respective sheet. After a reference run, test strips were inserted and automatically fixed. One of the fixing clamping jaws is located on a fixed part of the measuring device, another sits on a movable slide, which now moves linearly away from the fixed clamping jaw. This tears the test strip apart while a dynamometer determines the required tensile force.

Burst pressure: With the measurement of the burst pressure, the sample is stretched over a round membrane with a pneumatic hold-down device. Subsequently, the membrane is filled with glycerine, which causes it to expand and penetrate the sheet to be measured. If the sheet tears due to excessive pressure, the membrane returns to its starting position and the next of the three test positions can be clamped. During the measurement, a manometer attached to the membrane determines the hydraulic burst pressure applied in kPa. Subsequently, the three measurement results were then summarised in a calculated average value.

Flexural rigidity: The measurement of the flexural rigidity was carried out by clamping the sample and bending it 5°, while a free end of the sample contacts a sensor of a load cell. The flexural stiffness is measured in mNm. Subsequently, the cardboard is rotated by a further 25° to a total of 30° of total bending, whereby the bending resistance is determined at the angles 7.5°, 15° and 30° in mN. For further consideration of the measured values, only the bending resistance value at a bending of 15° and the rigidity values at 5° are considered.

The results of the measurements are summarised in the table in FIG. 1. Surprisingly, the different fibre material mixtures used for the tests showed clear differences in the measured strength values. It can be seen that the mixed pomace achieves higher values in terms of flexural resistance and rigidity compared to the tea pomace. This can be attributed to its higher coarse content in the herb mixture in the form of e.g. burnet root pieces or mint branches. The long, stable fibres of these fractions and the resulting higher average fibre length give the paper a high flexural strength. As a result, the mixed pomace paper with 25% herb content achieved the highest value for flexural rigidity and flexural resistance.

The tea pomace, which is finer compared to the mixed pomace (smaller average fibre length), produces a lower spec. volume in the paper, whereby its density increases with the same thickness and the fibre-fibre connections are strengthened. As a result, the tea pomace achieves slightly better values in the burst pressure test compared to the mixed pomace.

It can also be observed that the herb fraction in the paper has an impact on the processability and strength of the paper. Paper with a high herb fraction of 55% could only be knocked off the screen to a limited extent on the sheet former. A herb content of 60% also caused considerable problems during dewatering. This is also the reason for the low, average grammage of these sheets. Furthermore, these sheets achieved less good strength values in bursting and bending tests. This can be attributed to the low fraction of pulp, more precisely the lack of short-fibre pulp. Short-fibre pulp has the main task of filling gaps in paper and thus creating better fibre-fibre cohesion. Long-fibre pulp can only compensate for this to a limited extent, as it primarily provides flexural rigidity and volume in the form of a high average fibre length and a large number of intact fibres. Due to the lack of this pulp fraction, there is no adequate fibre-fibre cohesion on the sheet former, such that the sieved fibre material layer can disintegrate when knocking off.

The freeness of the final fibre suspension also has an influence on the leaf quality. In all tests of the first series of tests, it can be seen that the strength values, be it burst pressure, tear length, tear resistance or bending resistance, increase due to a refinement of the freeness (high number of revolutions). This can be explained by an increased fibrillation of the fibres, which creates a better fibre-fibre cohesion. During fibrillation, the secondary fibre walls are exposed by squeezing, which leads to an enlargement of the specific fibre surface. As a result, more active binding sites can be formed on the surface of the fibre, which increases the fibre-fibre cohesion.

The laboratory tests clearly showed good mixtures and freeness for the herb paper production. In general, it was found that milling the fibre mixture is of great importance for the future paper properties. Furthermore, the fraction of short-fibre pulp was an important factor for the processability and strength of the paper. Without the addition of this pulp, the strength values dropped significantly in all strength measurements.

The fibre material mixture with 25% herb fibres from mixed pomace, 25% grass fibres, 20% long-fibre pulp and 30% short-fibre pulp has proven to be a very good combination of parameters. The grass fibres form an ecologically excellent substitute for pulp in paper. Nevertheless, the paper also contains 20% long-fibre pulp and 30% short-fibre pulp, as these are beneficial for the processability and strength. Due to this combination, the paper achieved the best values for tear length, tear strength and flexural rigidity in the test.

In the strength values, there was a clear difference between paper purely containing pulp, grass paper and the herb paper. The pulp paper achieves very good fibre cohesion due to its intact, chemically processed fibres. As a result, the pulp paper has very good values in all mechanical properties. Nevertheless, it turned out in the test that the rough sometimes also root-containing (wood-like) herb fibre mixtures also achieve better flexural strength values in herb paper than pure pulp paper.

All herb paper samples show a distinct green tone, which was produced by the introduction of herbs. The paper becomes optically more interesting but also bumpier with decreasing freeness. In addition, the surface of the herb paper becomes very inhomogeneous at low freeness <1000, which can lead to problems when coating, laminating or printing. With fine freeness >1000 a homogeneous and smooth surface is created, since no large fibres disturb the paper image or the paper surface.

From an olfactory point of view, the herb paper has a pleasant herb note, which gives it a very natural “touch”.

For a production of a paper, a paperboard or a cardboard with industrial equipment, the herb fibre material for the fibre material mixture according to the invention was subjected to a suitable preparation. The herb pomace was dried and processed into pellets, as they are usually used in industrial production.

The drying takes place in a drum dryer. This type of drying ensures permanent mixing of the pomace to be dried. This reliably prevents moisture pockets and minimizes the drying time. The inlet temperature of the herbs in the drum dryer corresponds approximately to the ambient temperature (when testing about 25°). The moisture content of the pomace is around 85-90% when it enters and is reduced to a moisture content of 10-12% within 3 minutes. The herb pomace passes the entire length of the drum three times before it leaves it again at a temperature of approx. 90° C. The drying process itself takes place at a drum end temperature of 125° C. The temperature at the hot air inlet of the drum is between 550° C. and 600° C. The volume flow of this hot air is around 50,000 m³/h, such that a maximum evaporation capacity of 6500 kg of water per hour is achieved.

FIG. 2 shows the detailed process sequence and the individual steps in the drying and pelletising system.

The process sequence can be summarised as follows. First of all, herb pomace 1 is provided. This is subjected to a dosage 2 and then chopped in a chopping step 3 and dried in a drying step 4. Heavy material is separated in a heavy material separation step 5 and fine material is separated in a fine material separation step 6. The resulting product from steps 5 and 6 is milled in a milling step 7 and the milled material is separated in a milling material separation step 8. This is followed by pelleting 9. The pelleted material is cooled in a cooling step 10 and then made available as end product 11.

During the process, inlet air 12 is supplied in drying step 4 and in cooling step 10. Exhaust air 13 is sucked out of the fine material separation step 6, during pelletising 9 and during the cooling step 10.

Milling step 7: After the pomace has been dried in drying step 4, it is milled in milling step 7 in a hammer mill. This is important to homogenize the fibre quality and size before pelletising 9, which improves the pellet quality. The freeness is selected via the hole diameter of the milling sieve. A diameter of 8 mm is preferably used, as the downstream pelletising machine is a Kollergang press (=pan mill), whereby a further milling process takes place. If a 5 mm sieve is used, due to the double milling, the fine fractions in the subsequent pellet would be too large, which would result in a significant increase in the burden of the machine wastewater.

When choosing the drying temperatures in drying step 4, one may approach from the highest temperature (180° C.) to the optimal temperature of 125° C. This prevents clogging due to undried pomace. As a result, the pellets produced contained a residual moisture of <10%, which is optimal for the preservation of the pellets. In addition, the herbs are dried gently enough such that ash formation from burning herb fines is avoided.

Pelletising 9: The pelletising 9 takes place after the separation of the transport air, which has conveyed here the dried and milled herbs through the pipelines of the system. The pan mill now pelletizes using two wheels the milled herbs in pellets with 8 mm diameter. The resulting forces produce an additional milling effect, which further homogenizes the herb particle sizes. Subsequently, the pellets are cooled using several belt coolers, as they tend to increase in humidity due to condensation as a result of their inherent heat due to drying and pelleting. Once the cooling process is complete, the herb fibre material pellets are available for the paper production.

For the paper to be produced on the industrial equipment, a fibre material mixture with 15% herbs, 15% grass and 70% pulp content was used. Again, a grammage of 250 g/m² was chosen. Although the laboratory tests showed that a fraction of 25% herb fibre material is optimal, a fraction of 15% was chosen for industrial production, since at the time of paper production it was not possible to provide a sufficiently large amount of herb fibre materials. Furthermore, the industrial equipment used has not yet been optimised for production with herbs or grass fibre materials.

For paper production, 7 t of herb pellets were fed into the production. In the pulper (mixing bucket) of the paper machine, the 7 tons of herb fibres were dissolved and mixed with a further 7 tons of grass fibres and 33 tons of pulp to form a fibre suspension. Subsequently, the fibre suspension was fed into the ongoing paper production process. Herewith, the paper machine goes through several 100 m of start-up waste, in which the desired herb fibre fraction cannot be guaranteed due to mixing with a previously used fibre suspension. After this waste had run through the paper machine, herb paper was constantly produced until the herb fibre suspension was used up.

After the paper was produced, the next day it was given a transparent starch primer. This is intended to improve the printability of the herb paper.

This herb paper industrially produced with 15% herb fibre fraction has several special properties. With increasing herb input, the properties such as the smell and the visual appearance can be further changed.

Visual appearance: The visual appearance of the herb paper appears in a beige, slightly green tone, with many small green and black herb or grass fibres. This gives the herb paper a very natural but also a new, unique or unknown visual appearance.

Haptics: Haptically, the herb paper is similar to an uncoated kraft or recycled paper.

Olfactorics: The smell of the herb paper is most intense immediately after production. Here, the paper has a clear herbaceous note.

For the use as packaging material, it is important that the herb paper does not give off any smell or taste to the packaged food. For this purpose, a Robinson test was carried out, with which the transfer behaviour was checked using small pieces of chocolate. For this purpose, 4 beaker glasses were filled with 3 strips (50 mm×150 mm) of herb paper and small chocolate pieces. Subsequently, the glasses were hermetically sealed and stored. After 5 days, the glasses were opened and the chocolates were evaluated in terms of smell and taste. In all 4 samples, the chocolate acquired no herb/grass taste or odour. It can therefore be rated as unproblematic in terms of smell/taste.

It follows that a paper, a paperboard or a cardboard with a fraction of fibre material retrieved from herbs is well suited for the packaging of food. The quality characteristics are suitable e.g. for a bag packaging, but also for a box packaging for which a higher flexural rigidity is required. Therefor, a packaging fibre material can be provided from a pomace that is produced in the food production, which has various ecological advantages for the packaging of the food, as explained at the beginning.

1. A fibre material mixture for the production of paper, paperboard and/or cardboard, which contains a fraction of a herb fibre material retrieved from a herb pomace and a fraction of pulp.

2. The fibre material mixture according to claim 1, wherein the fraction of herb fibre material is 5% to 70%, preferably 30% to 60%, and particularly preferably 40% to 50%, of a total weight of fibre materials in the mixture.

3. The fibre material mixture according to claim 1, wherein the herb fibre material consists of a mixture of fibre materials retrieved from different herb species.

4. The fibre material mixture according to claim 1, wherein herbs for retrieval of the herb fibre material are selected from the herb species burnet, speedwell, sage, elderflower, thyme, ribwort, lady's mantle, primrose, mallow, horehound, peppermint, yarrow, marshmallow, verbena, hops, chamomile, poppy, lavender, orange blossom, orange leaves, rose blossom, vervain, apple mint, nettle, bergamot mint, ginger mint, lime mint, stevia and/or subspecies thereof.

5. The fibre material mixture according to claim 1, wherein the mixture contains a weight fraction of 30% to 95% of pulp.

6. The fibre material mixture according to claim 1, wherein the pulp fraction is composed of a larger part of short-fibre pulp and a smaller part of long-fibre pulp.

7. The fibre material mixture according to claim 1, wherein the mixture contains a fraction of fibre material retrieved from grass, wherein a weight fraction of grass fibre material corresponds to half of the weight fraction of herb fibre material to the double of the weight fraction of herb fibre material.

8. The fibre material mixture according to claim 1, wherein it has a weight fraction of 20%-30% of herb fibre material (preferably 25%), a weight fraction of 20%-30% of grass fibre material (preferably 25%) and a weight fraction of at least 40% of pulp (preferably 50%), with all weight fractions together giving a total weight of fibre materials in the mixture of 100%.

9. A method for providing a fibre material for the production of paper, paperboard and/or cardboard, in which herbs are used as fibre raw material, which are mechanically and/or chemically decomposed and processed into a pomace for retrieval of the fibre material.

10. The method according to claim 9, wherein herb cellulose remains in the herb pomace and other herb components are extracted.

11. The method according to claim 9, wherein the herbs are selected from the herb species burnet, speedwell, sage, elderflower, thyme, ribwort, lady's mantle, primrose, mallow, horehound, peppermint, yarrow, marshmallow, verbena, hops, chamomile, poppy, lavender, orange blossom, orange leaves, rose blossom, vervain, apple mint, nettle, bergamot mint, ginger mint, lime mint, stevia and/or subspecies thereof.

12. The method according to claim 9, wherein a herb pomace, produced from the herbs, is dried at a temperature between 50° C. to 140° C. (preferably 125° C.) (Residual moisture of <10%) (drum dryer).

13. The method according to claim 9, wherein the herb pomace is dried and subsequently milled in a first milling process to a fibre length of 5 mm to 10 mm (preferably at most 8 mm).

14. The method according to claim 13, wherein the dried and milled herb pomace is subjected to a second milling process in a press.

15. A method for producing paper, paperboard and/or cardboard, in which the fibre material mixture according to claim 1 and/or a herb fibre material in which herbs are used as fibre raw material, which are mechanically and/or chemically decomposed and processed into a pomace for retrieval of the fibre material is used.

16. The method according to claim 15, wherein the fibre material mixture is whipped with water to form a suspension and the fibre materials in the suspension are milled with a freeness of 2500 to 3500 (preferably 3000).

17. Paper, paperboard or cardboard produced from the fibre material mixture according to claim 1 and/or from a herb fibre material in which herbs are used as fibre raw material, which are mechanically and/or chemically decomposed and processed into a pomace for retrieval of the fibre material.

18. A packaging for a food, which is at least partially made of paper, paperboard and/or cardboard, wherein the paper, the paperboard and/or the cardboard has a fraction of fibre material, which is retrieved from pomace originating from the production of the food.

19. The packaging according to claim 18, wherein the food is made at least partially from herbs and the fraction of fibre material is provided from a herb pomace, the herb pomace originating from the production of the herb food.

20. The packaging according to claim 19, wherein the fraction of fibre material is provided by a method in which herbs are used as fibre raw material, which are mechanically and/or chemically decomposed and processed into a pomace for retrieval of the fibre material.
